(19) United States
(12) Patent Application Publication
(10) Pub. No.: US 2013/0016361 A1
(43) Pub. Date: Jan. 17, 2013

(54) STAGE APPARATUS

(71) Applicants: Sang Wook Park, Suwon-si (KR); In Bae Jang, Seoul (KR); Sang Don Jang, Suwon-si (KR); Oui Serg Kim, Seongnam-si (KR)

(72) Inventors: Sang Wook Park, Suwon-si (KR); In Bae Jang, Seoul (KR); Sang Don Jang, Suwon-si (KR); Oui Serg Kim, Seongnam-si (KR)

(73) Assignee: SAMSUNG ELECTRONICS CO., LTD., Suwon-si (KR)

(21) Appl. No.: 13/547,387

(22) Filed: Jul. 12, 2012

(30) Foreign Application Priority Data
Jul. 13, 2011 (KR) 1020110069446

(51) Int. Cl. G01B 11/14

(52) U.S. Cl. 356/500; 356/498

(57) ABSTRACT

The stage apparatus includes a stage having a range of movement on a stage base, an interferometer and a fixed mirror that are installed outside the stage on the stage base, and a first movable mirror disposed on the stage to reflect light, which is introduced from the interferometer, toward the fixed mirror, and to reflect the light, which is received after being reflected by the fixed mirror, to the interferometer.

### CROSS-REFERENCE TO RELATED APPLICATION

This application claims the benefit of Korean Patent Application No. 2011-0069446, filed on Jul. 13, 2011 in the Korean Intellectual Property Office, the entire disclosure of which is incorporated herein by reference.

### BACKGROUND

1. Field

Embodiments of the present disclosure relate to a stage apparatus using an interferometer in monitoring a position of a stage such that a stage is precisely controlled.

2. Description of the Related Art

In order to form a pattern of several micrometers (μm) on a large scale substrate at a repetition level of 0.1 μm through an exposure process, a stage having a long stroke suitable for the size of the large scale substrate needs to operate at a repetition level of 0.1 μm. However, when a position of the stage is measured using a linear scale that is used for controlling a general stage, a repetition level of 0.1 μm is not easy to achieve with respect to such a long stroke. Accordingly, the position of a stage is measured by an interferometer system.

According to the interferometer system, light (laser) is radiated to a mirror installed on a stage and an interferometer measures the change in frequency of a returning light being reflected by the mirror so that the movement of the stage is measured based on the Doppler effect.

### SUMMARY

At least one example embodiment provides a stage apparatus ensuring an easy placement and/or management of an interferometer. At least one example embodiment provides a mirror that is used to monitor and/or measure the movement of a stage.

Additional aspects of the disclosure will be set forth in part in the description which follows and, in part, will be obvious from the description, or may be learned by practice of the disclosure.

In accordance with an example embodiment, a stage apparatus includes a stage, an interferometer, a fixed mirror, and a first movable mirror. The stage has a range of movement on a stage base. The interferometer and the fixed mirror are installed outside the stage on the stage base. The first movable mirror is disposed on the stage to reflect light, which is introduced from the interferometer, toward the fixed mirror, and to reflect the light, which is received after being reflected by the fixed mirror, to the interferometer.

The range of movement of the stage corresponds to a plane formed by an X-axis and a Y-axis, and the interferometer includes an X-axis interferometer configured to measure a movement of the stage in the X-axis and a Y-axis interferometer configured to measure a movement of the stage in the Y-axis.

The X-axis interferometer forms a light path, which is used to monitor and/or measure the movement of the stage in the X-axis direction, in cooperation with the first movable mirror and the fixed mirror, and the first movable mirror is installed on the stage at an angle with respect to the X-axis and the Y-axis to satisfy a condition for interreflection between the X-axis and the fixed mirror.

The X-axis interferometer emits the light in a Y-axis direction, the fixed mirror has a reflection surface along the Y-axis direction, and the first movable mirror is disposed at an angle of 45 degrees with respect to the X-axis and the Y-axis.

The stage base is configured to support the stage, wherein the fixed mirror is disposed on the stage base at one side of the Y-axis direction.

The interferometer is disposed at one side of an X-axis direction on the stage base.

The X-axis interferometer is formed using a pair of X-axis interferometers, and the Y-axis interferometer is formed using a pair of Y-axis interferometers.

The stage apparatus further includes a second movable mirror installed on the stage to reflect a light, which is introduced from the Y-axis interferometer, back to the Y-axis interferometer.

The second movable mirror has a reflection surface along an X-axis direction.

The stage is configured to have a Y-axis direction stroke larger than an X-axis direction stroke.

In accordance with another example embodiment of the present disclosure, a stage apparatus includes a X-axis interferometer, a fixed mirror and a first movable mirror. The stage has an X-Y plane according to an X-Y coordinate system of an X-axis and a Y-axis as a range of movement of the stage. The X-axis interferometer is installed outside the stage to monitor and/or measure a movement of the stage in the X-axis. The fixed mirror is disposed outside the stage and has a reflection surface along the Y-axis. The first movable mirror is disposed on the stage and configured to form a light path, which is used to monitor and/or measure a movement of the stage in the X-axis, in cooperation with the X-axis interferometer and the fixed mirror.

The X-axis interferometer emits a light in a Y-axis direction, and the first movable mirror is disposed at an angle of 45 degrees with respect to the X-axis and the Y-axis.

### BRIEF DESCRIPTION OF THE DRAWINGS

These and/or other aspects of the disclosure will become apparent and more readily appreciated from the following description of the embodiments, taken in conjunction with the accompanying drawings of which:

FIGS. 1 to 3 are perspective views illustrating a state of a movement of a stage apparatus according to an example embodiment of the present disclosure.

FIG. 4 is a plan view illustrating the stage apparatus according to the example embodiment of the present disclosure.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Example embodiments will now be described more fully with reference to the accompanying drawings, in which example embodiments are shown. Example embodiments may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, the thicknesses of layers and regions are exaggerated for clarity. Like reference numerals in the drawings denote like elements, and thus their description will be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

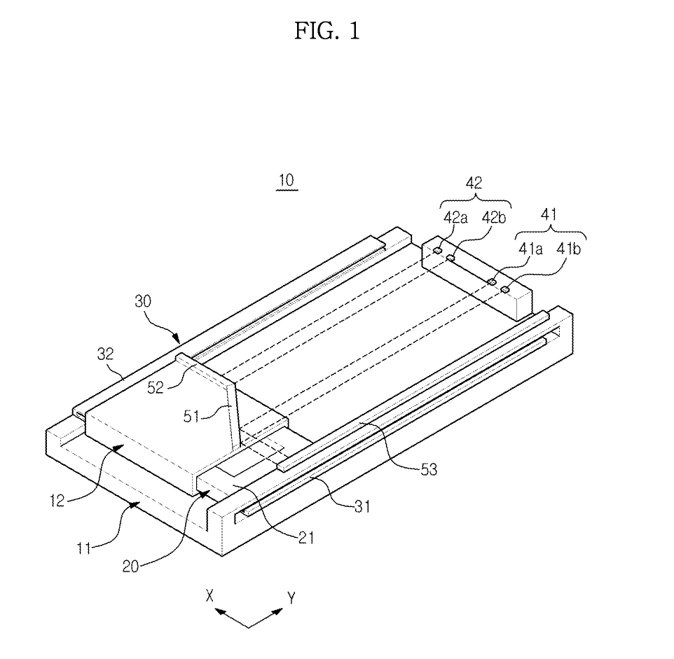

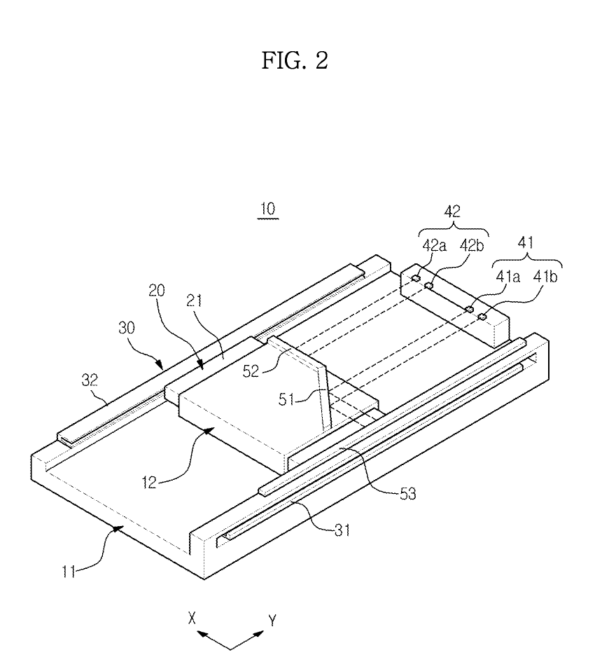

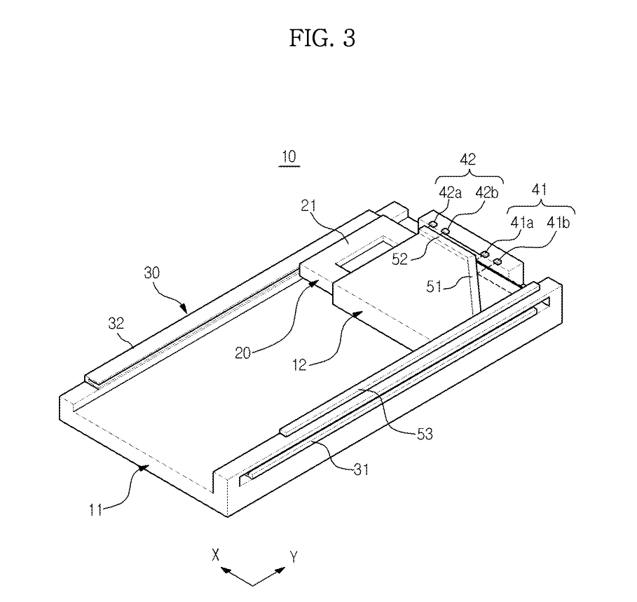

Referring to FIGS. 1 to 4, a stage apparatus 10 includes a stage base 11 configured to support the stage apparatus 10, a stage 12 movably installed on the stage base 11, a driving unit to move the stage 12, and an interferometer system configured to monitor and/or measure the position and operation of the stage 12.

According to the stage apparatus 10, the stage 12 is provided as to enable the movement on an X-Y plane according to an X-Y coordinate system, and the driving unit includes an X-axis driving unit 20 and a Y-axis driving unit 30.

The X-axis driving unit 20 includes a guide block 21 configured to guide a movement of the stage 12 in the X-axis, and an X-axis driving motor (not shown) to generate a driving force for a X-axis movement. The Y-axis driving unit 30 includes the stage base 11 to guide the stage 12 and the guide block 21, and driving motors 31 and 32 for a Y-axis movement.

The interferometer system includes interferometers including an X-axis interferometer 41 and a Y-axis interferometer 42 and mirrors 51, 52, and 53 including a first movable mirror 51, a second movable mirror 52, and a fixed mirror 53. The mirrors 51, 52 and 53 may be, for example, full or partially (e.g., half) silvered mirrors that may include, for example, a single or multiple mirrored surfaces configured as layers (e.g., laminate). The interferometers 41 and 42 are configured to radiate light and measure a frequency of the light returning after being reflected, and thereby monitor and/or measure a movement of the stage 12. The mirrors 51, 52, and 53 are configured to reflect the light that is emitted from the interferometers 41 and 42.

The interferometers 41 and 42 include the X-axis interferometer 41 and the Y-axis interferometer 42 that are configured to measure the X-axis movement and the Y-axis movement of the stage 12, respectively.

The X-axis interferometer 41 is disposed at one side of the X-direction on the stage base 11 to emit light in parallel to the Y-axis direction perpendicular to the X-axis direction.

The Y-axis interferometer 42 is also disposed at one side of the X-direction on the stage base 11 to emit light in parallel to the Y-axis direction perpendicular to the X-axis direction.

The mirrors 51, 52, and 53 include the first movable mirror 51, the second movable mirror 52, and the fixed mirror 53. The first and the second movable mirrors 51 and 52 are installed on the stage 12. The fixed mirror 53 is installed on the stage base 11 outside the stage 12 on one side of the Y-axis direction on the stage base 11.

The first movable mirror 51 serves as an element used to measure the X-axis movement of the stage 12 in cooperation with the X-axis interferometer 41 and the fixed mirror 53. The first movable mirror 51 is disposed or installed at an angle with respect to the X-axis and the Y-axis. The first movable mirror 51 reflects the light emitted from the X-axis interferometer 41 toward the fixed mirror 53. The fixed mirror 53 reflects the received light to the first movable mirror 51. The first movable mirror 52 reflects the light to the X-axis interferometer 41. In the case when the X-axis interferometer 41 emits light in the Y-axis direction and the fixed mirror is disposed in the Y-axis direction according to the embodiment of the present disclosure, the first movable mirror 41 needs to be disposed at an angle of 45 degrees with respect to the X-axis and the Y-axis to satisfy a condition of the above reflection path.

In order for the second movable mirror 52 to reflect light emitted from the Y-axis interferometer 42 to return the light to the Y-axis interferometer 42, the second movable mirror 52 is disposed on one side of the X-axis direction in the stage 12, that is, the X-axis direction perpendicular to the direction of light emitted from the Y-axis interferometer 42.

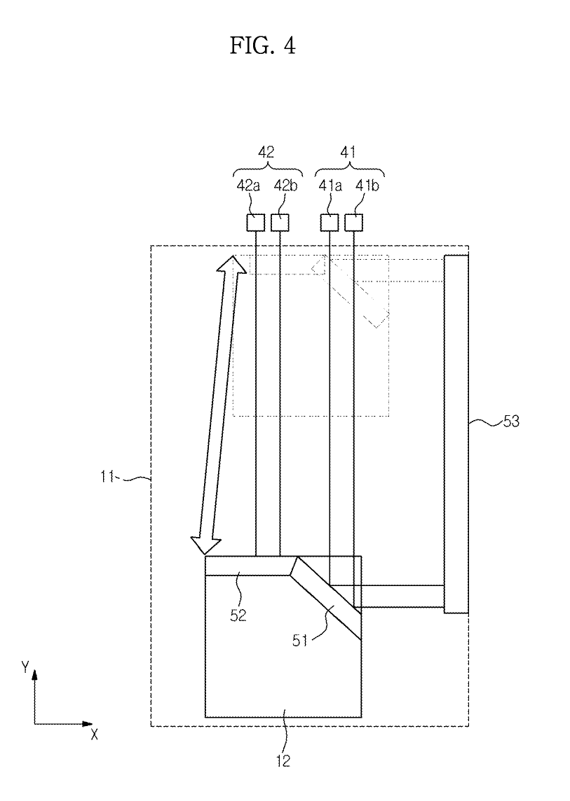

The second movable mirror 52 has a length greater than or equal to an X-axis stroke of the stage 12 to reflect and return light emitted from the Y-axis interferometer 42 within an area of X-axis movement of the stage when the stage apparatus 10 operates as shown in FIG. 4.

Similarly, the first movable mirror 51 is configured to reflect light emitted from the X-axis interferometer 41 while corresponding to the X-axis movement of the stage 12 when the stage 12 moves the entire area of movement as shown in FIG. 4. The first movable mirror 51 is dispoed at an angle of 45 degrees with respect to the X-axis and the Y-axis. Accordingly, the minimum length of the first movable mirror 51 may be a value obtained by dividing the X-axis stroke of the stage 12 by sine 45 degrees (or cosine 45 degrees) and then by adding a light interval of X-axis interferometers 41a and 41b to the division result.

As described above, the fixed mirror 53 is disposed on one side of the Y-axis direction on the stage base 11 outside the stage 12. The fixed mirror 53 has a length greater than or equal to a Y-axis stroke of the stage 12 to reflect and return the light introduced from the X-axis interferometer 41 and the first movable mirror 51 to the X-axis interferometer 41 and the first movable mirror 51 within the entire area of movement of the stage 12.

The fixed mirror 53, which is installed at one side of the stage base 11 outside the stage 12, is not limited thereto. However, since the first and the second movable mirrors 51 and 52 are installed on the stage 12, if the length of the first and the second movable mirrors 51 and 52 are excessively long, various drawbacks may be presented.

For example, an excessively long mirror may not be easily installed on a stage. In addition, a stage error associated with a change on a mirror surface may be large. If a length of a mirror exceeds the width or the length of a stage, a size of the stage base also needs to increase. In addition, a mirror installed beyond the boundary of a stage may be interfered by an external structure or may be damaged by an unexpected collision.

In this regard, according to the stage apparatus of an embodiment of present disclosure, a long axis stroke is set to the Y-axis direction stroke between the X-axis direction and the Y-axis direction, the fixed mirror 53 is installed on one side of the stage base 11 in the Y-axis direction, and the first and the second movable mirrors 51 and 53 are installed on the stage. Hereinafter, benefits associated with the above configuration are described.

The first and the second movable mirrors 51 and 52 correspond to a range of the X-axis direction movement that represents a relatively short stroke, accordingly, the first and the second movable mirrors 51 and 52 have a short length. In particular, the first movable mirror 51, which needs to be disposed at an angle with respect to the X-axis and the Y-axis on the stage 12, may be installed while enhancing the spatial efficiency of the stage 12 and preventing the first and the second movable mirrors 51 and 52 from being deviated from the upper surface of the stage 12. As a result, the space occupied by the stage base 11 is reduced; an error caused by a change on a mirror surface is reduced; a change of the first and the second movable mirrors 51 and 52 being broken is reduced; and the assembly and the maintenance of the mirrors 51, 52, and 53 are easily achieved.

In addition, the fixed mirror 53 having a long length enables a long stroke to be read using a single interferometer without discontinuation of the light of the interferometer during an operation of the stage 12 in the long axis stroke. In a case where a long stroke is measured using a short movable mirror, the stroke needs to be divided into a plurality of regions and a plurality of interferometers needs to be installed to correspond to the plurality of regions. However, according to the present disclosure, there is no need to increase the number of interferometers, and a control criteria for interferometers does not need to be changed and thus errors caused by the change on the control criteria do not exist.

In addition, the fixed mirror 53 is installed outside the stage 12 and the movable mirror 51 is disposed at an angle inside the stage, so the X-axis interferometer 41 and the Y-axis interferometer 42 may be installed in the same direction, thereby ensuring an easy maintenance and installation as compared with a case where the X-axis interferometer and the Y-axis interferometer are installed in each axis direction. In particular, an alignment of the interferometer 41 and 42 is easily achieved.

Referring to drawings, the X-axis interferometer 41 may be provided with a pair of X-axis interferometers 41 a and 41 b. The X-axis interferometers 41a and 41b may be disposed while being spaced apart from each other. Similarly, the Y-axis interferometer 42 may be also provided with a pair of Y-axis interferometers 42a and 42b. The Y-axis interferometers 42a and 42b may be disposed while being spaced apart from each other.

As each of the X-axis interferometer 41 and the Y-axis interferometer 42 is provided in plural, a change in yaw as well as the displacement along each axis is measured through the change in frequency of light. In detail, when light emitted from the X-axis interferometer 41 is incident perpendicular to the fixed mirror 53 via the first movable mirror 51 and then returns to the X-axis interferometer 41 via the first movable mirror 51 after being reflected by the fixed mirror 53, the change in light path is measured based on the change in frequency of the returned light. Then, a Y-axis direction displacement is subtracted from the distance traveled by the light, thereby obtaining an X-axis direction displacement and a Yaw value.

Although the first movable mirror 51 and the second movable mirror 52 according to the embodiment of the present disclosure are separately provided from each other and installed on the stage 12, the present disclosure is not limited thereto. For example, the first movable mirror 51 and the second movable mirror 52 may be integrally provided with each other and may be installed on the stage 12.

Although the stage apparatus according to the embodiment of the present disclosure is applied to a stage apparatus for performing exposure on a large scale substrate, the present disclosure is not limited thereto. For example, the present disclosure may be applied to other stage apparatus for different uses, such as a stage apparatus for testing a substrate or a stage apparatus for manufacturing a mask.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A stage apparatus comprising:
a stage having a range of movement on a stage base;
an interferometer;
a fixed mirror, the interferometer and the fixed mirror being installed outside the stage on the stage base; and
a first movable mirror disposed on the stage to reflect light, which is introduced from the interferometer, toward the fixed mirror, and to reflect the light, which is received after being reflected by the fixed mirror, to the interferometer.

2. The stage apparatus of claim 1, wherein the range of movement corresponds to a plane formed by an X-axis and a Y-axis, and
the interferometer comprises an X-axis interferometer configured to measure a movement of the stage in the X-axis and a Y-axis interferometer configured to measure a movement of the stage in the Y-axis.

3. The stage apparatus of claim 2, wherein the X-axis interferometer forms a light path, which is used to measure the movement of the stage in the X-axis, in cooperation with the first movable mirror and the fixed mirror, and the first movable mirror is installed on the stage at an angle with respect to the X-axis and the Y-axis to satisfy a condition for interreflection between the X-axis and the fixed mirror.

4. The stage apparatus of claim 3, wherein the X-axis interferometer emits the light in a Y-axis direction, the fixed mirror has a reflection surface along the Y-axis direction, and the first movable mirror is disposed at an angle of 45 degrees with respect to the X-axis and the Y-axis.

5. The stage apparatus of claim 4, wherein the stage base is configured to support the stage, wherein the fixed mirror is disposed on the stage base at one side of the Y-axis direction.

6. The stage apparatus of claim 5, wherein the interferometer is disposed at one side of an X-axis direction on the stage base.

7. The stage apparatus of claim 4, wherein the X-axis interferometer is formed with a pair of X-axis interferometers, and the Y-axis interferometer is formed with a pair of Y-axis interferometers.

8. The stage apparatus of claim 4, further comprising a second movable mirror installed on the stage to reflect a light, which is introduced from the Y-axis interferometer, back to the Y-axis interferometer.

9. The stage apparatus of claim 8, wherein the second movable mirror has a reflection surface along an X-axis direction.

10. The stage apparatus of claim 2, wherein the stage is configured to have a Y-axis direction stroke larger than an X-axis direction stroke.

11. A stage apparatus comprising:
a stage having an X-Y plane according to an X-Y coordinate system of an X-axis and a Y-axis as a range of movement of the stage;
a Y-axis interferometer installed outside the stage to monitor a movement of the stage in the Y-axis;
a fixed mirror disposed outside the stage and having a reflection surface along the Y-axis; and
a first movable mirror disposed on the stage and configured to form a light path, which is used to monitor a movement of the stage in the X-axis, in cooperation with the X-axis interferometer and the fixed mirror.

12. The stage apparatus of claim 11, wherein the X-axis interferometer emits a light in a Y-axis direction, and the first movable mirror is disposed at an angle of 45 degrees with respect to the X-axis and the Y-axis.
